(19) United States
(12) Patent Application Publication
(10) Pub. No.: US 2017/0228618 A1
(43) Pub. Date: Aug. 10, 2017

(54) VIDEO CLASSIFICATION METHOD AND APPARATUS

(71) Applicants: Huawei Technologies Co., Ltd., Shenzhen (CN); Fudan University, Shanghai (CN)

(72) Inventors: Yugang JIANG, Shanghai (CN); Zuxuan WU, Shanghai (CN); Xiangyang XUE, Shanghai (CN); Zichen GU, Beijing (CN); Zhenhua CHAI, Shenzhen (CN)

(21) Appl. No.: 15/495,541

(22) Filed: Apr. 24, 2017

Related U.S. Application Data
(63) Continuation of application No. PCT/CN2015/080871, filed on Jun. 5, 2015.

(30) Foreign Application Priority Data
Oct. 24, 2014 (CN) 201410580006.0

(51) Int. Cl. G06K 9/62; G06N 3/04; G06F 17/16; G06N 3/08

(52) U.S. Cl. CPC G06K 9/6271; G06N 3/08; G06N 3/04; G06F 17/16; G06K 9/6215

(57) ABSTRACT

A video classification method and apparatus are provided in embodiments of the present invention. The method includes: establishing a neural network classification model according to a relationship between features of video samples and a semantic relationship of the video samples; obtaining a feature combination of a to-be-classified video file; and classifying the to-be-classified video file by using the neural network classification model and the feature combination of the to-be-classified video file The neural network classification model is established according to the relationship between the features of the video samples and the semantic relationship of the video samples, and the relationship between the features and the semantic relationship are fully considered. Therefore, video classification accuracy are improved.

### CROSS-REFERENCE TO RELATED APPLICATIONS

This application is a continuation of International Application No. PCT/CN2015/080871, filed on Jun. 5, 2015, which claims priority to Chinese Patent Application No. 201410580006.0, filed on Oct. 24, 2014. The disclosures of the aforementioned applications are hereby incorporated by reference in their entireties.

### TECHNICAL FIELD

Embodiments of the present invention relate to the field of computer technologies, and in particular, to a video classification method and apparatus.

### BACKGROUND

Video classification refers to processing and analyzing a video by using visual information, auditory information, and action information of the video, and determining and recognizing an action and an event appearing in the video. Video classification is applied extremely widely, for example, to intelligent monitoring and video data management.

In the prior art, video classification is performed by using an early fusion technology. Specifically, different features extracted from a video file or kernel matrices of the different features are combined linearly, and then input to a classifier for analysis, so as to classify a video. However, according to the method in the prior art, a relationship between features and a semantic relationship are neglected. Therefore, video classification accuracy is not high.

### SUMMARY

Embodiments of the present invention provide a video classification method and apparatus, to improve video classification accuracy.

A first aspect of the embodiments of the present invention provides a video classification method, including:

establishing a neural network classification model according to a relationship between features of video samples and a semantic relationship of the video samples;

obtaining a feature combination of a to-be-classified video file; and

classifying the to-be-classified video file by using the neural network classification model and the feature combination of the to-be-classified video file.

With reference to the first aspect, in a first possible implementation manner, the establishing a neural network classification model according to a relationship between features of video samples and a semantic relationship of the video samples includes:

obtaining a weight matrix of a neural network classification model fusion layer and a weight matrix of a neural network classification model classification layer according to the relationship between the features of the video samples and the semantic relationship of the video samples; and

establishing the neural network classification model according to the weight matrix of the neural network classification model fusion layer and the weight matrix of the neural network classification model classification layer.

With reference to the first possible implementation manner of the first aspect, in a second possible implementation manner, the obtaining a weight matrix of a neural network classification model fusion layer and a weight matrix of a neural network classification model classification layer according to the relationship between the features of the video samples and the semantic relationship of the video samples includes:

obtaining the weight matrix of the neural network classification model fusion layer and the weight matrix of the neural network classification model classification layer by optimizing a target function, where

the target function is:

$${min}_{W , Ω} ζ + \frac{{λ}_{1}}{2} {‖ {W}_{E} ‖}_{2 , 1} + \frac{{λ}_{2}}{2} tr ( {W}_{L - 1} Ω {W}_{L - 1}^{T} )$$

$$s . t Ω \geq 0 tr ( Ω ) = 1$$

where ζ represents a deviation between a predictor and a real value of the video samples, ζ₁ represents a preset first weight coefficient, ζ₂ represents a preset second weight coefficient, W_{E} represents the weight matrix of the neural network classification model fusion layer, each column of W_{E} is corresponding to a type of feature, W_{L-1} represents the weight matrix of the neural network classification model classification layer, W_{L-1}^{T} represents transposition of W_{L-1}, ∥W_{E}∥_{2,1} represents an L21 norm of W_{E}, Ω represents a positive semi-definite symmetric matrix used to represent the semantic relationship, and an initial value of Ω is an identity matrix.

With reference to the second possible implementation manner of the first aspect, in a third possible implementation manner, the obtaining the weight matrix of the neural network classification model fusion layer and the weight matrix of the neural network classification model classification layer by optimizing a target function includes:

obtaining the weight matrix of the neural network classification model fusion layer and the weight matrix of the neural network classification model classification layer by optimizing the target function by using a proximal gradient method.

With reference to the third possible implementation manner of the first aspect, in a fourth possible implementation manner, the optimizing the target function by using a proximal gradient method includes:

initializing the weight matrix of the neural network classification model fusion layer and the weight matrix of the neural network classification model classification layer that are in the target function;

obtaining a deviation between an output predictor and an actual value by inputting the features of the video samples; and

adjusting the weight matrix of the neural network classification model fusion layer and the weight matrix of the neural network classification model classification layer according to the deviation until the deviation is less than a preset threshold.

A second aspect of the embodiments of the present invention provides a video classification apparatus, including:

a model establishment module, configured to establish a neural network classification model according to a relationship between features of video samples and a semantic relationship of the video samples;

a feature extraction module, configured to obtain a feature combination of a to-be-classified video file; and

a classification module, configured to classify the to-be-classified video file by using the neural network classification model and the feature combination of the to-be-classified video file.

With reference to the second aspect, in a first possible implementation manner, the model establishment module is specifically configured to obtain a weight matrix of a neural network classification model fusion layer and a weight matrix of a neural network classification model classification layer according to the relationship between the features of the video samples and the semantic relationship of the video samples; and establish the neural network classification model according to the weight matrix of the neural network classification model fusion layer and the weight matrix of the neural network classification model classification layer.

With reference to the first possible implementation manner of the second aspect, in a second possible implementation manner, the model establishment module is specifically configured to obtain the weight matrix of the neural network classification model fusion layer and the weight matrix of the neural network classification model classification layer by optimizing a target function, where

the target function is:

$${min}_{W , Ω} ζ + \frac{{λ}_{1}}{2} {‖ {W}_{E} ‖}_{2 , 1} + \frac{{λ}_{2}}{2} tr ( {W}_{L - 1} Ω {W}_{L - 1}^{T} )$$

$$s . t Ω \geq 0 tr ( Ω ) = 1$$

where ζ represents a deviation between a predictor and a real value of the video samples, ζ₁ represents a preset first weight coefficient, ζ₂ represents a preset second weight coefficient, W_{E} represents the weight matrix of the neural network classification model fusion layer, each column of W_{E} is corresponding to a type of feature, W_{L-1} represents the weight matrix of the neural network classification model classification layer, W_{L-1}^{T} represents transposition of W_{L-1}, ∥W_{E}∥_{2,1} represents an L21 norm of W_{E}, Ω represents a positive semi-definite symmetric matrix used to represent the semantic relationship, and an initial value of Ω is an identity matrix.

With reference to the second possible implementation manner of the second aspect, in a third possible implementation manner, the model establishment module is specifically configured to obtain the weight matrix of the neural network classification model fusion layer and the weight matrix of the neural network classification model classification layer by optimizing the target function by using a proximal gradient method.

With reference to the third possible implementation manner of the second aspect, in a fourth possible implementation manner, the model establishment module is specifically configured to initialize the weight matrix of the neural network classification model fusion layer and the weight matrix of the neural network classification model classification layer that are in the target function; obtain a deviation between an output predictor and an actual value by inputting the features of the video samples; and adjust the weight matrix of the neural network classification model fusion layer and the weight matrix of the neural network classification model classification layer according to the deviation until the deviation is less than a preset threshold.

According to the video classification method and apparatus provided in the embodiments of the present invention, a neural network classification model is established according to a relationship between features of video samples and a semantic relationship of the video samples; a feature combination of a to-be-classified video file is obtained; and the to-be-classified video file is classified by using the neural network classification model and the feature combination of the to-be-classified video file. The neural network classification model is established according to the relationship between the features of the video samples and the semantic relationship of the video samples, and the relationship between the features and the semantic relationship are fully considered. Therefore, video classification accuracy may be improved.

### BRIEF DESCRIPTION OF DRAWINGS

To describe the technical solutions in the embodiments of the present invention more clearly, the following briefly describes the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a schematic flowchart of Embodiment 1 of a video classification method according to the present invention;

FIG. 2 is a schematic flowchart of Embodiment 2 of a video classification method according to the present invention;

FIG. 3 is a schematic structural diagram of Embodiment 1 of a video classification apparatus according to the present invention; and

FIG. 4 is a schematic structural diagram of Embodiment 2 of a video classification apparatus according to the present invention.

### DESCRIPTION OF EMBODIMENTS

The following clearly describes the technical solutions in the embodiments of the present invention with reference to the accompanying drawings in the embodiments of the present invention. Apparently, the described embodiments are merely some but not all of the embodiments of the present invention. All other embodiments obtained by a person of ordinary skill in the art based on the embodiments of the present invention without creative efforts shall fall within the protection scope of the present invention.

According to the present invention, a neural network classification model is trained by using a relationship between features of video samples and a semantic relationship of the video samples, and an optimal weight of each connection in the neural network classification model is obtained, so as to improve video classification accuracy.

Specific embodiments are used in the following to describe in detail the technical solutions of the present invention. The following several specific embodiments may be combined with each other, and a same or similar concept or process may not be described repeatedly in some embodiments.

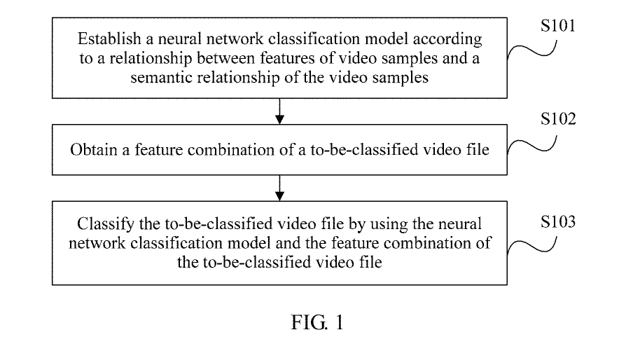

FIG. 1 is a schematic flowchart of Embodiment 1 of a video classification method according to the present invention. As shown in FIG. 1, the method in this embodiment is as follows.

S101. Establish a neural network classification model according to a relationship between features of video samples and a semantic relationship of the video samples.

A neural network described in this embodiment of the present invention refers to an artificial neural network. The artificial neural network is a computing model simulating a biological neural system, and includes multiple layers. Each layer is a nonlinear variation of a previous layer. The artificial neural network includes a deep neural network and a conventional neural network. Compared with the conventional neural network, the deep neural network may obtain complex feature expressions of different layers from low to high. A structure of the deep neural network is extremely similar to a multi-layer perceptual structure of a human cerebral cortex, so that the deep neural network is based on a biological theory to some extent, and is popular in the current research.

The neural network is a group of connected input/output units, each input/output unit is referred to as a neuron, and each connection is associated with a weight. In a training phase of the neural network, a relatively accurate prediction result may be output by adjusting a weight associated with each connection.

The video samples described in this embodiment of the present invention refer to video files used when the neural network classification model is being trained.

In this embodiment of the present invention, a weight matrix of a neural network classification model fusion layer and a weight matrix of a neural network classification model classification layer are obtained by using a structure of a deep neural network according to the relationship between the features of the video samples and the semantic relationship of the video samples; and the neural network classification model is established according to the weight matrix of the neural network classification model fusion layer and the weight matrix of the neural network classification model classification layer.

The obtaining a weight matrix of a neural network classification model fusion layer and a weight matrix of a neural network classification model classification layer according to the relationship between the features of the video samples and the semantic relationship of the video samples is specifically: obtaining the weight matrix of the neural network classification model fusion layer and the weight matrix of the neural network classification model classification layer by optimizing a target function. The target function has a well-designed regularized constraint condition. Therefore, the relationship between the features and the semantic relationship can be fully considered in a same neural network classification model, and video classification accuracy is improved.

The target function having a regularized constraint condition in this embodiment of the present invention is shown as follows:

$${min}_{W , Ω} ζ + \frac{{λ}_{1}}{2} {‖ {W}_{E} ‖}_{2 , 1} + \frac{{λ}_{2}}{2} tr ( {W}_{L - 1} Ω {W}_{L - 1}^{T} )$$

$$s . t Ω \geq 0 tr ( Ω ) = 1$$

where ζ represents a deviation between a predictor and a real value of the video samples, ζ₁ represents a preset first weight coefficient, ζ₂ represents a preset second weight coefficient, W_{E} represents the weight matrix of the neural network classification model fusion layer, each column of W_{E} is corresponding to a type of feature, W_{L-1} represents the weight matrix of the neural network classification model classification layer, W_{L-1}^{T} represents transposition of W_{L-1}, ∥W_{E}∥_{2,1} represents an L21 norm of W_{E}, Ω represents a positive semi-definite symmetric matrix used to represent the semantic relationship, and an initial value of Ω is an identity matrix.

Usually, the weight matrices of the neural network classification model are initialized randomly. In a training phase, nonlinear mapping is constantly performed on the features (raw input) of the video samples by using a forward propagation algorithm, so as to obtain a predictor of the video samples. There is often a deviation between the predictor of the video samples and a real value. The deviation between the predictor and the real value is minimized for different video samples by constantly adjusting the weight matrix of the fusion layer and the weight matrix of the classification layer. ζ is used to measure an empirical loss of a deviation between a real value of all video samples in an entire data set and a predictor obtained by means of network forward propagation.

In the present invention, to fully use the relationship between the features and the semantic relationship and improve video classification accuracy, a term ∥W_{E}∥_{2,1} and a term tr(W_{L-1} ΩW_{L-1}^{T}) are added to the target function, where W_{E} represents the weight matrix of the neural network classification model fusion layer, each column of W_{E} is corresponding to a type of feature, and W_{L-1} represents the weight matrix of the neural network classification model classification layer.

Meanings of minimizing different norms are shown as follows:

relationship between features (fusion layer weight):

$$[ \begin{matrix}{w}_{11} & {w}_{12} & … & {w}_{1 m} \\ {w}_{21} & {w}_{22} & … & {w}_{2 m} \\ ⋮ & ⋮ & & ⋮ \\ {w}_{i 1} & {w}_{i 2} & … & {w}_{im}\end{matrix} ] {\begin{matrix}minimzing an \\ {I}_{21} norm\end{matrix}}_{\to } [ \begin{matrix}0 & 0 & … & 0 \\ {w}_{21} & {w}_{22} & … & {w}_{2 m} \\ ⋮ & ⋮ & & ⋮ \\ 0 & 0 & … & 0\end{matrix} ]$$

semantic relationship (classification layer weight):

$$[ \begin{matrix}1 & 0 & … & 0 \\ 0 & 1 & … & ⋮ \\ ⋮ & ⋮ & ⋱ & ⋮ \\ 0 & 0 & … & 1\end{matrix} ] {\begin{matrix}minimzing an \\ trace norm\end{matrix}}_{\to } [ \begin{matrix}{w}_{12} & … & {w}_{14} \\ 1 & … & ⋮ \\ ⋮ & ⋱ & ⋮ \\ {w}_{41} & … & 1\end{matrix} ]$$

$$Ω = \frac{{( {w}_{L - 1}^{T} {w}_{L - 1} )}^{\frac{1}{2}}}{tr ( {( {w}_{L - 1}^{T} {w}_{L - 1} )}^{\frac{1}{2}} )}$$

∥W_{E}∥_{2,1} means to first calculate an L2 norm for each row of the matrix to obtain a vector, and then calculate an L1 norm for the vector. When the norm is being minimized, the target function corresponding to extremely few non-zero rows is minimum, so that matrix rows are sparse. Therefore, the remaining non-zero rows are a same model shared by all different features, and may reflect consistency between the features.

Ω is a positive semi-definite symmetric matrix for depicting the semantic relationship, is first initialized into an identity matrix, and is updated by using the weight of the classification layer in a training process of the neural network classification model, so as to obtain the semantic relationship. Each element on an off-diagonal of the positive semi-definite symmetric matrix measures different semantic relationships.

The foregoing target function may be optimized by using a proximal gradient method (PGM) in a backward propagation frame. The proximal gradient method is a most commonly used optimization algorithm for solving large-scale data, and usually may be relatively fast in convergence, to efficiently solve an optimization problem. Therefore, a weight of each connection in the neural network classification model is obtained. Usually, the weight matrix of the neural network classification model fusion layer and the weight matrix of the neural network classification model classification layer that are in the target function are initialized; a deviation between an output predictor and an actual value is obtained by inputting the features of the video samples; and the weight matrix of the neural network classification model fusion layer and the weight matrix of the neural network classification model classification layer are adjusted according to the deviation until the deviation is less than a preset threshold.

More specifically, detailed steps of obtaining the neural network classification model are as follows:

1. Randomly initialize a network weight.

2. Repeat the following steps for K times in a training process.

21) First abstract different features to a same dimension by means of multi-layer nonlinear transformation.

22) Fuse the different features in the neural network classification model.

23) Classify the fused features, to obtain a forward propagation error, that is, a deviation between an actual value and a predictor.

24) Transfer the error backward from an L^{th} layer, fix Ω, and update the weight matrix W_{L-1} of the classification layer by using a constraint of Ω by means of gradient descent, so as to consider the semantic relationship when updating W_{L-1}; for the weight matrix W_{E} of the fusion layer, update W_{E} under a constraint of an L21 norm, so as to learn Ω by using the relationship between the features and by using updated W_{E} after W_{E} is updated.

End.

A neural network classification model that can accurately perform video classification may be obtained by means of training by using the steps in S101.

S102: Obtain a feature combination of a to-be-classified video file.

There are multiple manners for obtaining the feature combination of the video file, and the present invention sets no limitation thereto.

Usually, multiple types of features of the to-be-classified video file may be obtained to improve a classification effect. Improved dense trajectory features are usually extracted as visual features, and the dense trajectory features include a 30-dimentional trajectory feature, a 96-dimentional histogram of gradients (histogram of gradients) feature, a 108-dimentional histogram of optical flow (histogram of optical flow) feature, and a 192-dimentional motion binary histogram (motion binary histogram) feature. The four types of features are further converted into a feature expression of a 4000-dimentional bag-of-words (bag-of-words). Audio features such as a mel-frequency cepstral coefficient (MFCC) and a spectrogram (Spectrogram)-based scale invariant feature transform (SIFT) may be further extracted.

S103: Classify the to-be-classified video file by using the neural network classification model and the feature combination of the to-be-classified video file.

That is, the feature combination of the to-be-classified video file is used as input of the neural network classification model, and a category to which the to-be-classified video file belongs is output by using the neural network classification model.

By using the neural network classification model, video classification processing may be almost completed in real time, so that efficiency is relatively high.

In this embodiment, a neural network classification model is established according to a relationship between features of video samples and a semantic relationship of the video samples; a feature combination of a to-be-classified video file is obtained; and the to-be-classified video file is classified by using the neural network classification model and the feature combination of the to-be-classified video file. The neural network classification model is established according to the relationship between the features of the video samples and the semantic relationship of the video samples, and the relationship between the features and the semantic relationship are fully considered. Therefore, video classification accuracy may be improved.

A video classification result generated by using the technical solution of the present invention may be applied to other video related technologies, such as video abstraction and video retrieval. During the video abstraction, a video may be divided into multiple clips, and then, semantic analysis is performed on the video by using a video classification technology in the present invention, to extract a meaningful video clip as a result of the video abstraction. During the video retrieval, semantic information of video content may be extracted by using the video classification technology in the present invention, so as to retrieve the video.

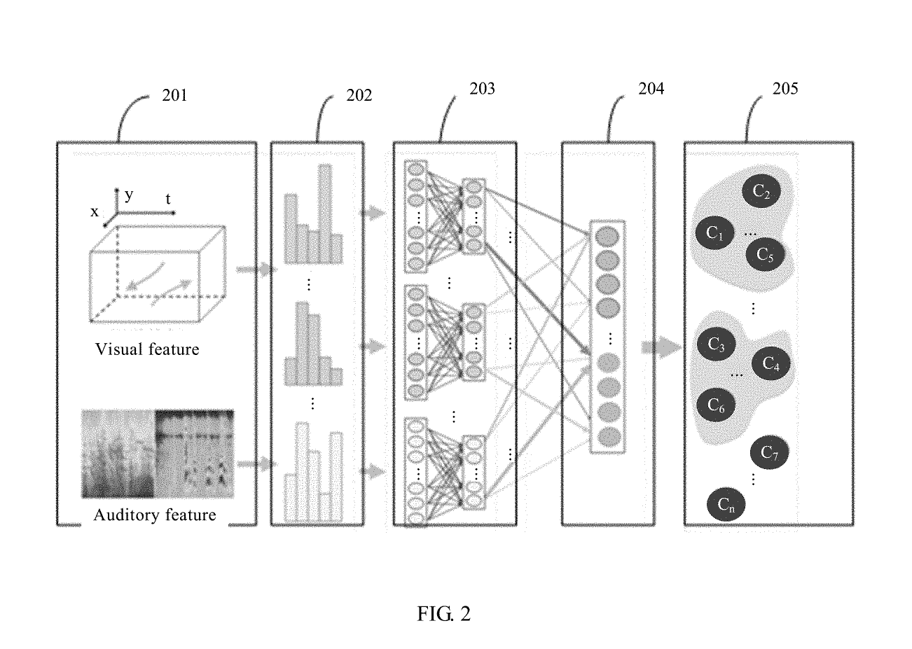

The present invention further provides an embodiment. As shown in FIG. 2, FIG. 2 is a schematic flowchart of Embodiment 2 of a video classification method according to the present invention. As shown in FIG. 2:

S201: Extract a visual feature and an auditory feature from a given video file.

S202: Quantize the extracted features, to obtain bag-of-words models corresponding to the features.

S203: Represent each bag-of-words model as a corresponding vector, and perform forward feature transformation on the vector.

S204: Perform feature fusion processing on features obtained after the forward feature transformation.

S205: Output a video classification result.

By using the method of the present invention, video classification processing may be almost completed in real time, so that efficiency is relatively high, and video classification accuracy is relatively high.

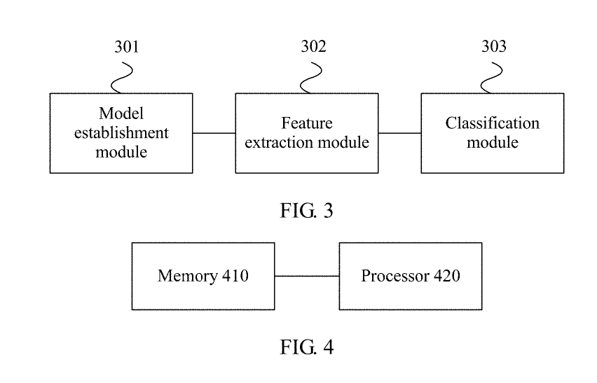

FIG. 3 is a schematic structural diagram of Embodiment 1 of a video classification apparatus according to the present invention. The apparatus in this embodiment includes a model establishment module 301, a feature extraction module 302, and a classification module 303. The model establishment module 301 is configured to establish a neural network classification model according to a relationship between features of video samples and a semantic relationship of the video samples.

The feature extraction module 302 is configured to obtain a feature combination of a to-be-classified video file.

The classification module 303 is configured to classify the to-be-classified video file by using the neural network classification model and the feature combination of the to-be-classified video file.

In the foregoing embodiment, the model establishment module 301 is specifically configured to obtain a weight matrix of a neural network classification model fusion layer and a weight matrix of a neural network classification model classification layer according to the relationship between the features of the video samples and the semantic relationship of the video samples; and establish the neural network classification model according to the weight matrix of the neural network classification model fusion layer and the weight matrix of the neural network classification model classification layer.

In the foregoing embodiment, the model establishment module 301 is specifically configured to obtain the weight matrix of the neural network classification model fusion layer and the weight matrix of the neural network classification model classification layer by optimizing a target function, where

the target function is:

$${min}_{W , Ω} ζ + \frac{{λ}_{1}}{2} {‖ {W}_{E} ‖}_{2 , 1} + \frac{{λ}_{2}}{2} tr ( {W}_{L - 1} Ω {W}_{L - 1}^{T} )$$

$$s . t Ω \geq 0 tr ( Ω ) = 1$$

where ζ represents a deviation between a predictor and a real value of the video samples, ζ₁ represents a preset first weight coefficient, ζ₂ represents a preset second weight coefficient, W_{E} represents the weight matrix of the neural network classification model fusion layer, each column of W_{E} is corresponding to a type of feature, W_{L-1} represents the weight matrix of the neural network classification model classification layer, W_{L-1}^{T} represents transposition of W_{L-1}, ∥W_{E}∥_{2,1} represents an L21 norm of W_{E}, Ω represents a positive semi-definite symmetric matrix used to represent the semantic relationship, and an initial value of Ω is an identity matrix.

In the foregoing embodiment, the model establishment module 301 is specifically configured to obtain the weight matrix of the neural network classification model fusion layer and the weight matrix of the neural network classification model classification layer by optimizing the target function by using a proximal gradient method.

In the foregoing embodiment, the model establishment module 301 is specifically configured to initialize the weight matrix of the neural network classification model fusion layer and the weight matrix of the neural network classification model classification layer that are in the target function; obtain a deviation between an output predictor and an actual value by inputting the features of the video samples; and adjust the weight matrix of the neural network classification model fusion layer and the weight matrix of the neural network classification model classification layer according to the deviation until the deviation is less than a preset threshold.

For other functions and operations of the apparatus in FIG. 3, refer to the foregoing process of the method embodiment in FIG. 1. To avoid repetition, details are not described herein again.

According to the apparatus in the embodiment shown in FIG. 3, a model establishment module establishes a neural network classification model according to a relationship between features of video samples and a semantic relationship of the video samples; a feature extraction module obtains a feature combination of a to-be-classified video file; and a classification module classifies the to-be-classified video file by using the neural network classification model and the feature combination of the to-be-classified video file. The neural network classification model is established according to the relationship between the features of the video samples and the semantic relationship of the video samples, and the relationship between the features and the semantic relationship are fully considered. Therefore, video classification accuracy may be improved.

FIG. 4 is a schematic structural diagram of Embodiment 2 of a video classification apparatus according to the present invention. As shown in FIG. 4, the apparatus in this embodiment includes a memory 410 and a processor 420. The memory 410 may include a random access memory, a flash memory, a read-only memory, a programmable read-only memory, a non-volatile memory, a register, or the like. The processor 420 may be a central processing unit (CPU). The memory 410 is configured to store an executable instruction. The processor 420 may execute the executable instruction stored in the memory 410. For example, the processor 420 is configured to establish a neural network classification model according to a relationship between features of video samples and a semantic relationship of the video samples; obtain a feature combination of a to-be-classified video file; and classify the to-be-classified video file by using the neural network classification model and the feature combination of the to-be-classified video file.

Optionally, in an embodiment, the processor 420 may be configured to obtain a weight matrix of a neural network classification model fusion layer and a weight matrix of a neural network classification model classification layer according to the relationship between the features of the video samples and the semantic relationship of the video samples; and establish the neural network classification model according to the weight matrix of the neural network classification model fusion layer and the weight matrix of the neural network classification model classification layer.

Optionally, in an embodiment, the processor 420 may be configured to obtain the weight matrix of the neural network classification model fusion layer and the weight matrix of the neural network classification model classification layer by optimizing a target function, where

the target function is:

$${min}_{W , Ω} ζ + \frac{{λ}_{1}}{2} {‖ {W}_{E} ‖}_{2 , 1} + \frac{{λ}_{2}}{2} tr ( {W}_{L - 1} Ω {W}_{L - 1}^{T} )$$

$$s . t Ω \geq 0 tr ( Ω ) = 1$$

where ζ represents a deviation between a predictor and a real value of the video samples, ζ₁ represents a preset first weight coefficient, ζ₂ represents a preset second weight coefficient, W_{E} represents the weight matrix of the neural network classification model fusion layer, each column of W_{E} is corresponding to a type of feature, W_{L-1} represents the weight matrix of the neural network classification model classification layer, W_{L-1}^{T} represents transposition of W_{L-1}, ∥W_{E}∥_{2,1} represents an L21 norm of W_{E}, Ω represents a positive semi-definite symmetric matrix used to represent the semantic relationship, and an initial value of Ω is an identity matrix.

Optionally, in an embodiment, the processor 420 may be configured to obtain the weight matrix of the neural network classification model fusion layer and the weight matrix of the neural network classification model classification layer by optimizing the target function by using a proximal gradient method.

Optionally, in an embodiment, the processor 420 may be configured to initialize the weight matrix of the neural network classification model fusion layer and the weight matrix of the neural network classification model classification layer that are in the target function;

obtain a deviation between an output predictor and an actual value by inputting the features of the video samples; and

adjust the weight matrix of the neural network classification model fusion layer and the weight matrix of the neural network classification model classification layer according to the deviation until the deviation is less than a preset threshold.

For other functions and operations of the apparatus in FIG. 4, refer to the foregoing process of the method embodiment in FIG. 1. To avoid repetition, details are not described herein again.

A person of ordinary skill in the art may understand that all or some of the steps of the method embodiments may be implemented by a program instructing relevant hardware. The program may be stored in a computer-readable storage medium. When the program runs, the steps of the method embodiments are performed. The foregoing storage medium includes: any medium that can store program code, such as a ROM, a RAM, a magnetic disk, or an optical disc.

Finally, it should be noted that the foregoing embodiments are merely intended for describing the technical solutions of the present invention, but not for limiting the present invention. Although the present invention is described in detail with reference to the foregoing embodiments, a person of ordinary skill in the art should understand that they may still make modifications to the technical solutions described in the foregoing embodiments or make equivalent replacements to some or all technical features thereof, without departing from the scope of the technical solutions of the embodiments of the present invention.

1. A video classification method, comprising:
establishing a neural network classification model according to (a) a relationship between features of video samples and (b) a semantic relationship of the video samples;
obtaining a feature combination of a to-be-classified video file; and
classifying the to-be-classified video file by using the neural network classification model and the feature combination of the to-be-classified video file.

2. The method according to claim 1, wherein the establishing the neural network classification model according to the relationship between the features of the video samples and the semantic relationship of the video samples comprises:
obtaining a weight matrix of a neural network classification model fusion layer and a weight matrix of a neural network classification model classification layer according to the relationship between the features of the video samples and the semantic relationship of the video samples; and
establishing the neural network classification model according to the weight matrix of the neural network classification model fusion layer and the weight matrix of the neural network classification model classification layer.

3. The method according to claim 2, wherein the obtaining the weight matrix of the neural network classification model fusion layer and the weight matrix of the neural network classification model classification layer according to the relationship between the features of the video samples and the semantic relationship of the video samples comprises:
obtaining the weight matrix of the neural network classification model fusion layer and the weight matrix of the neural network classification model classification layer by optimizing a target function, wherein
the target function is:
$${min}_{W , Ω} ζ + \frac{{λ}_{1}}{2} {‖ {W}_{E} ‖}_{2 , 1} + \frac{{λ}_{2}}{2} tr ( {W}_{L - 1} Ω {W}_{L - 1}^{T} )$$
$$s . t Ω \geq 0 tr ( Ω ) = 1$$
wherein ζ represents a deviation between a predictor and a real value of the video samples, ζ₁ represents a preset first weight coefficient, ζ₂ represents a preset second weight coefficient, W_{E} represents the weight matrix of the neural network classification model fusion layer, each column of W_{E} corresponds to a type of feature, W_{L-1} represents the weight matrix of the neural network classification model classification layer, W_{L-1}^{T} represents transposition of W_{L-1}, ∥W_{E}∥_{2,1} represents an L21 norm of W_{E}, Ω represents a positive semi-definite symmetric matrix used to represent the semantic relationship, and an initial value of Ω is an identity matrix.

4. The method according to claim 3, wherein the obtaining the weight matrix of the neural network classification model fusion layer and the weight matrix of the neural network classification model classification layer by optimizing the target function comprises:
obtaining the weight matrix of the neural network classification model fusion layer and the weight matrix of the neural network classification model classification layer by optimizing the target function by using a proximal gradient method.

5. The method according to claim 4, wherein the optimizing the target function by using the proximal gradient method comprises:
initializing the weight matrix of the neural network classification model fusion layer and the weight matrix of the neural network classification model classification layer that are in the target function;
obtaining a deviation between an output predictor and an actual value by inputting the features of the video samples; and
adjusting the weight matrix of the neural network classification model fusion layer and the weight matrix of the neural network classification model classification layer according to the deviation until the deviation is less than a preset threshold.

6. A video classification apparatus, comprising:
a processor; and a memory coupled to the processor, where the memory stores processor-executable instructions which when executed causes the processor to implement operations including:
establishing a neural network classification model according to a relationship between features of video samples and a semantic relationship of the video samples;
obtaining a feature combination of a to-be-classified video file; and
the to-be-classified video file by using the neural network classification model and the feature combination of the to-be-classified video file.

7. The apparatus according to claim 6, wherein the operations further include: obtaining a weight matrix of a neural network classification model fusion layer and a weight matrix of a neural network classification model classification layer according to the relationship between the features of the video samples and the semantic relationship of the video samples; and establishing the neural network classification model according to the weight matrix of the neural network classification model fusion layer and the weight matrix of the neural network classification model classification layer.

8. The apparatus according to claim 7, wherein the operations further include: obtaining the weight matrix of the neural network classification model fusion layer and the weight matrix of the neural network classification model classification layer by optimizing a target function, wherein
the target function is:
$${min}_{W , Ω} ζ + \frac{{λ}_{1}}{2} {‖ {W}_{E} ‖}_{2 , 1} + \frac{{λ}_{2}}{2} tr ( {W}_{L - 1} Ω {W}_{L - 1}^{T} )$$
$$s . t Ω \geq 0 tr ( Ω ) = 1$$
wherein ζ represents a deviation between a predictor and a real value of the video samples, ζ₁ represents a preset first weight coefficient, ζ₂ represents a preset second weight coefficient, W_{E} represents the weight matrix of the neural network classification model fusion layer, each column of W_{E} corresponds to a type of feature, W_{L-1} represents the weight matrix of the neural network classification model classification layer, W_{L-1}^{T} represents transposition of W_{L-1}, ∥W_{E}∥_{2,1} represents an L21 norm of W_{E}, Ω represents a positive semi-definite symmetric matrix used to represent the semantic relationship, and an initial value of Ω is an identity matrix.

9. The apparatus according to claim 8, wherein the operations further include: obtaining the weight matrix of the neural network classification model fusion layer and the weight matrix of the neural network classification model classification layer by optimizing the target function by using a proximal gradient method.

10. The apparatus according to claim 9, wherein the operations further include: initializing the weight matrix of the neural network classification model fusion layer and the weight matrix of the neural network classification model classification layer that are in the target function; obtaining a deviation between an output predictor and an actual by inputting the features of the video samples; and adjusting the weight matrix of the neural network classification model fusion layer and the weight matrix of the neural network classification model classification layer according to the deviation until the deviation is less than a preset threshold.
